(19) United States
(12) Patent Application Publication
(10) Pub. No.: US 2016/0258555 A1
(43) Pub. Date: Sep. 8, 2016

(54) STRUCTURE FOR ATTACHING BAND CLIP TO CORRUGATED TUBE

(71) Applicant: SUMITOMO WIRING SYSTEMS, LTD., Yokkaichi-shi, Mie (JP)

(72) Inventor: Yutaka MATSUMURA, Yokkaichi, Mie (JP)

(21) Appl. No.: 15/027,889

(22) PCT Filed: Sep. 30, 2014
(86) PCT No.: PCT/JP2014/076009

§ 371 Date: Apr. 7, 2016

(30) Foreign Application Priority Data
Oct. 21, 2013 (JP) 2013-218284

(51) Int. Cl. F16L 3/233; F16L 3/12; F16L 3/137

(52) U.S. Cl. CPC F16L 3/233; F16L 3/137; F16L 3/1222

(57) ABSTRACT

A structure for attaching a band clip to a corrugated tube, provided with: a corrugated tube that has a plurality of ring-shaped ribs and a plurality of ring-shaped grooves, and that is for enclosing a wire harness; and a band clip for fixing the corrugated tube to an attachment target object. The band clip has a projecting portion that projects toward an outer circumferential surface of the corrugated tube when the band clip is attached to the corrugated tube. The corrugated tube has: a groove-shaped ring-shaped recessed portion into which the projecting portion is fittable; and a plurality of protruding portions that are provided at predetermined intervals in a circumferential direction of the ring-shaped recessed portion, and that are engageable with the projecting portion.

### TECHNICAL FIELD

The present invention relates to a structure for attaching a band clip to a corrugated tube.

### BACKGROUND ART

Generally speaking, in order to fix a corrugated tube for protecting the outer periphery of a wire harness to a vehicle body or the like, a band-type clip (hereinafter referred to as “band clip”) is often used, considering the cost and the installation area size.

A band clip is configured to have a loop shape when a belt portion is inserted into a buckle portion, and, in this state, to be able to clamp the outer periphery of a corrugated tube when the belt portion is fastened. It is possible to fix the corrugated tube to a vehicle body or the like by inserting a clip portion of the band clip, which is clamping the corrugated tube, into a fixing hole formed in the vehicle body or the like.

However, since the inner circumferential surface of the belt portion of such a band clip is likely to slip along the outer circumferential surface of the corrugated tube, the band clip might unintentionally rotate in the circumferential direction relative to the corrugated tube, and workability when attaching the corrugated tube to the vehicle body or the like is poor. On the other hand, if the belt portion is too tightly fastened in order to prevent the band clip from rotating, there is the possibility of the belt portion crushing the corrugated tube.

In order to eliminate such a problem, there is a conventionally-known band clip attaching structure in which a plurality of protruding portions are provided on the inner circumferential surface of the band clip, particularly on the inner circumferential surface of the belt portion, along the longitudinal direction such that the plurality of protruding portions dig into the outer circumferential surface of the corrugated tube when the belt portion is fastened to the corrugated tube, and the band clip is thus prevented from rotating (see Patent Document 1, for example).

### SUMMARY OF INVENTION

### Technical Problem

However, the conventional band clip attaching structure has the problem that, if the belt portion of the band clip is not sufficiently fastened, the plurality of protruding portions cannot sufficiently dig into the corrugated tube, and the band clip cannot be reliably prevented from rotating.

The present invention is made to solve the above-described problems, and aims to provide a structure for attaching a band clip to a corrugated tube, with which the band clip attached to the corrugated tube can be reliably prevented from rotating.

### Solution to Problem

To achieve the above-described aim, a structure for attaching a band clip to a corrugated tube according to one aspect of the present invention is provided with: a corrugated tube that has a plurality of ring-shaped ribs and a plurality of ring-shaped grooves, and that is for enclosing a wire harness; and a band clip for fixing the corrugated tube to an attachment target object. The band clip has a projecting portion that projects toward an outer circumferential surface of the corrugated tube when the band clip is attached to the corrugated tube. The corrugated tube has: a groove-shaped ring-shaped recessed portion that is provided in parallel with the ring-shaped grooves and into which the projecting portion is fittable; and a plurality of protruding portions that are provided at predetermined intervals in a circumferential direction of the ring-shaped recessed portion, and that are engageable with the projecting portion.

With this configuration, the structure for attaching a band clip to a corrugated tube according to one aspect of the present invention is configured such that the projecting portion of the band clip is fitted into the ring-shaped recessed portion of the corrugated tube when the band clip is attached to the corrugated tube. Also, the projecting portion of the band clip is configured such that, in the state of being fitted into the ring-shaped recessed portion, the projecting portion can be restricted from moving in the circumferential direction due to the plurality of protruding portions provided for the ring-shaped recessed portion of the corrugated tube.

Therefore, the structure for attaching a band clip to a corrugated tube according to one aspect of the present invention is capable of reliably preventing the band clip attached to the corrugated tube from rotating.

Also, in the structure for attaching a band clip to a corrugated tube having the above-described configuration, it is preferable that the ring-shaped grooves, the projecting portion, and the ring-shaped recessed portion are formed such that a relationship W1<W2<W3 is satisfied, where W1 denotes widths of the ring-shaped grooves in an axial direction that is orthogonal to the circumferential direction, W2 denotes a width of the projecting portion in the axial direction, and W3 denotes a width of the ring-shaped recessed portion in the axial direction.

With this configuration, each element of the structure for attaching a band clip to a corrugated tube according to one aspect of the present invention is formed such that the relationship “the widths W1 of the ring-shaped grooves<the width W2 of the projecting portion<the width W3 of the ring-shaped recessed portion” is satisfied, and therefore the projecting portion of the band clip can be reliably fitted into the ring-shaped recessed portion when the band clip is attached to the corrugated tube. Also, when attaching the band clip to the corrugated tube, it is possible to prevent the projecting portion of the band clip from being mistakenly fitted into a ring-shaped groove.

In the structure for attaching a band clip to a corrugated tube having the above-described configuration, it is preferable that widths of the protruding portions in an axial direction that is orthogonal to the circumferential direction are set to be smaller than a width of the ring-shaped recessed portion in the axial direction.

With this configuration, the structure for attaching a band clip to a corrugated tube according to one aspect of the present invention can be configured such that any protruding portion of the corrugated tube does not come into contact with a pair of ring-shaped ribs that the protruding portion is adjacent to. Consequently, a gap is formed between each protruding portion and the pair of ring-shaped ribs that the protruding portion is adjacent to, and the corrugated tube is allowed to bend due to the presence of the gap. For this reason, it is possible to ensure preferable bendability of the corrugated tube.

### Advantageous Effects of Invention

With the present invention, it is possible to provide a structure for attaching a band clip to a corrugated tube, with which the band clip attached to the corrugated tube can be reliably prevented from rotating.

### BRIEF DESCRIPTION OF DRAWINGS

FIG. 1 is a perspective view showing a situation in which a band clip has been attached to a corrugated tube according to one embodiment of the present invention.

FIG. 2A is a perspective view of the band clip according to one embodiment of the present invention, in which the clip portion side of the band clip is illustrated as the upper surface.

FIG. 2B is a perspective view of the band clip according to one embodiment of the present invention, in which the projecting portion side of the band clip is illustrated as the upper surface.

FIG. 3 is a perspective view of the corrugated tube according to one embodiment of the present invention.

FIG. 4A is a plan view showing the corrugated tube according to one embodiment of the present invention.

FIG. 4B is an end elevational view of the corrugated tube shown in FIG. 4A along A-A.

FIG. 5 is a partial cross-sectional view showing a situation in which the band clip has been attached to the corrugated tube according to one embodiment of the present invention.

FIG. 6 is a perspective view of a modification of the corrugated tube according to one embodiment of the present invention.

FIG. 7A is a plan view of the corrugated tube shown in FIG. 6.

FIG. 7B is an end elevational view of the corrugated tube shown in FIG. 7A along B-B.

FIG. 8 is a plan view in which a primary part of the corrugated tube shown in FIG. 6 is enlarged.

FIG. 9 is a plan view showing another shape of the protruding portion shown in FIG. 8

FIG. 10 is a perspective view showing another modification of the corrugated tube according to one embodiment of the present invention.

FIG. 11A is a plan view of the corrugated tube shown in FIG. 10.

FIG. 11B is a cross-sectional view of the corrugated tube shown in FIG. 11A along C-C.

### DESCRIPTION OF EMBODIMENTS

The following describes a structure for attaching a band clip to a corrugated tube according to one embodiment of the present invention with reference to the drawings.

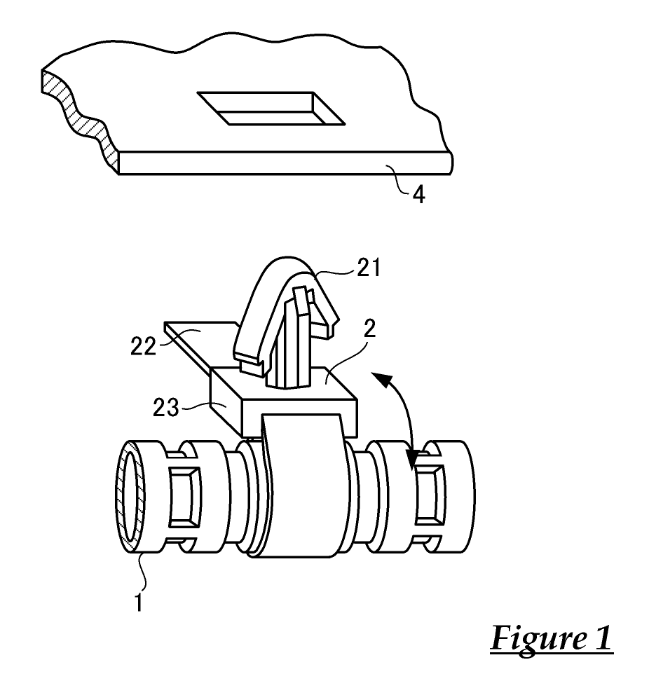

The present embodiment describes, as shown in FIG. 1, a structure for attaching a band clip 2 for, when attaching the band clip 2 to a corrugated tube 1 for enclosing a wire harness (not shown in the drawing) for routing wires in a car or the like, restricting the band clip 2 from rotating in the circumferential direction (the direction indicated by the arrow shown in the drawing) relative to the corrugated tube 1.

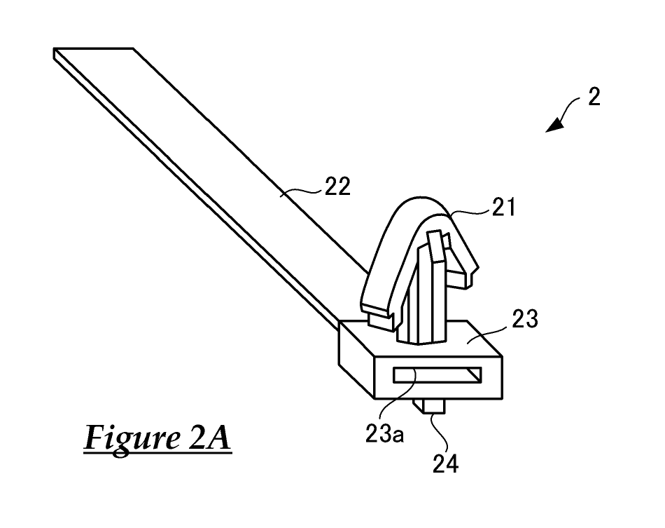

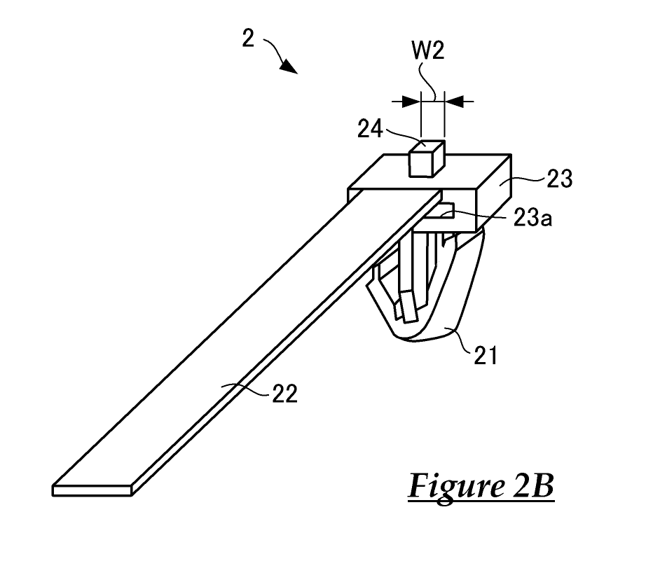

As shown in FIG. 2A, the band clip 2 according to the present embodiment includes a clip portion 21, a belt portion 22, and a clip locking portion 23.

The clip portion 21 is provided on the clip locking portion 23, and is to be inserted into an attachment hole 4a formed in an attachment target object 4 (see FIG. 1) such as a reinforcement in the body panel or the instrument panel of a car, thereby fixing the band clip 2 to the attachment target object 4. With this configuration, the corrugated tube 1 is fixed to the attachment target object 4, with the band clip 2 being interposed therebetween.

The belt portion 22 is a belt that has ends and that extends from the clip locking portion 23 so as to have a predetermined length. The belt portion 22 is made from flexible resin material, and is configured such that a free end thereof is to be inserted into a belt insertion hole 23a, which is described below, of the clip locking portion 23 when the belt portion 22 is wound around the corrugated tube 1.

Also, although not shown in the drawings, the belt portion 22 is provided with a plurality of locking grooves that are to be locked by a locking piece provided within the belt insertion hole 23a described below. Note that the configuration for locking the free end side of the belt portion 22 into the belt insertion hole 23a is not limited to locking grooves.

The clip locking portion 23 has the function of locking the belt portion 22 wound around the corrugated tube 1. Specifically, the belt insertion hole 23a, into which the belt portion 22 is to be inserted from the free end side, is formed in the clip locking portion 23. This belt insertion hole 23a is provided with a locking piece that locks a locking groove of the belt portion 22, which is not shown in the drawing.

Therefore, when the belt portion 22 is inserted into the belt insertion hole 23a from the free end side, the locking piece locks one of the plurality of locking grooves of the belt portion 22. Consequently, the belt portion 22 is prevented from coming off of the belt insertion hole 23a.

Also, as shown in FIG. 2B, the clip locking portion 23 is provided with a projecting portion 24 on the surface that is opposite the surface on which the clip portion 21 is formed.

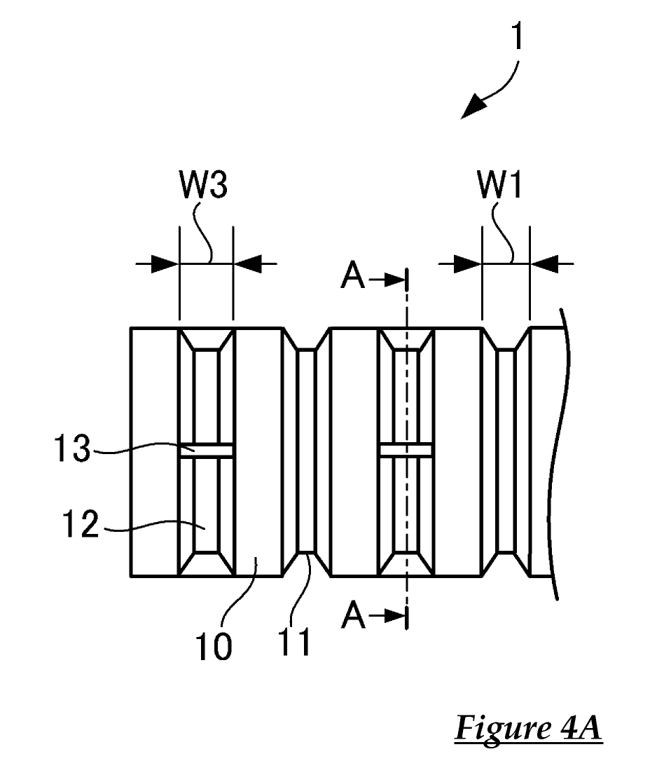

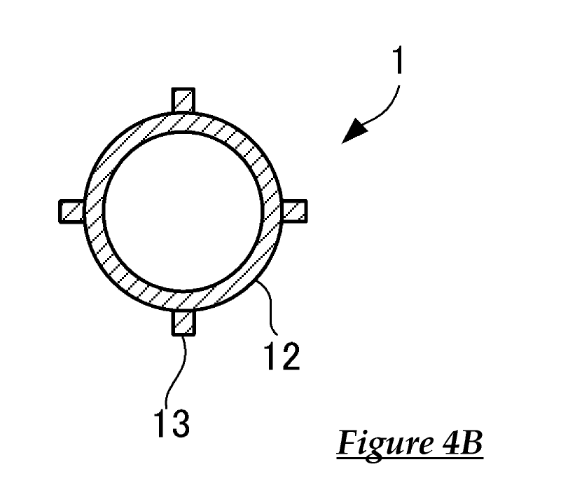

The projecting portion 24 is configured to project toward the outer circumferential surface of the corrugated tube 1 when the band clip 2 is attached to the corrugated tube 1. The projecting portion 24 is configured to, when the band clip 2 is attached to the corrugated tube 1, be fitted into a ring-shaped recessed portion 12 described below (see FIG. 4A), which is provided in the corrugated tube 1.

The height, i.e., the length in the direction of projection, of the projecting portion 24 is set to be smaller than at least the depths of the ring-shaped recessed portions 12, i.e., the length from the outer circumferential surfaces of the ring-shaped ribs 10 described below to the bottom surfaces of the ring-shaped recessed portions 12. Consequently, when the band clip 2 is attached to the corrugated tube 1, no gap is formed between the clip locking portion 23 and the outer circumferential surface of the corrugated tube 1, and the clip locking portion 23 and the outer circumferential surface of the corrugated tube 1 can be brought into close contact with each other.

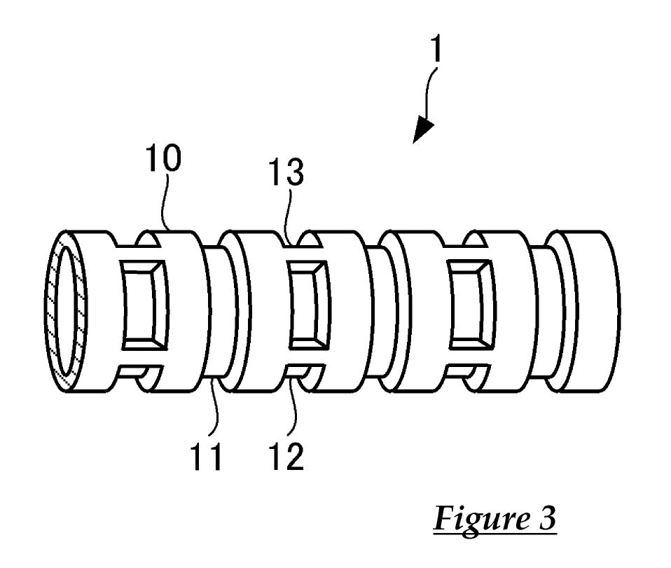

As shown in FIG. 3, the corrugated tube 1 is a cylindrical member that has, due to having a so-called bellows structure, flexibility in the longitudinal direction, i.e., the axial direction that is orthogonal to the circumferential direction of the corrugated tube 1. The corrugated tube 1 is configured to enclose a wire harness therein.

Specifically, the corrugated tube 1 has a plurality of ring-shaped ribs 10 and a plurality of ring-shaped grooves 11, which are arranged in the axial direction at predetermined intervals. The corrugated tube 1 is an integrally formed member made from thermoplastic resin such as polyamide (PA), polypropylene (PP), polybutyleneterephtalate (PBT), or ABS resin.

In the corrugated tube 1, a cut that extends along the axial direction, not shown in the drawing, is formed. Thus, the corrugated tube 1 is configured to make it possible to form a gap therein along the axial direction by pulling the cut toward both sides using a predetermined jig, and to make it possible to insert a wire harness into the inside from the gap.

Also, the corrugated tube 1 has a groove-shaped ring-shaped recessed portion 12 into which the projecting portion 24 of the clip locking portion 23 is fitted when the band clip 2 is attached to the corrugated tube 1.

A plurality of ring-shaped recessed portions 12 are provided at predetermined intervals in the axial direction, in parallel with the above-described ring-shaped grooves 11. In the present embodiment, the ring-shaped recessed portions 12 and the ring-shaped grooves 11 are arranged one after another in the axial direction. The arrangement of the ring-shaped recessed portions 12 and the ring-shaped grooves 11 can be optionally determined. For example, the number of ring-shaped recessed portions 12 may be reduced to be smaller than the number of ring-shaped grooves 11.

Also, each ring-shaped recessed portion 12 has a plurality of protruding portions 13 provided at predetermined intervals along the circumferential direction. In the present embodiment, four protruding portions 13 are provided as shown in FIG. 4B, and these four protruding portions 13 are displaced from one another by 90° in the circumferential direction. Note that the number of protruding portions 13 is not limited to four, and may be two, three, or five or more as described below. However, it is preferable that the number is two to four, considering the bendability of the corrugated tube 1.

The protruding portions 13 each have a rib shape for coupling a pair of ring-shaped ribs 10 that are adjacent to each other, with a ring-shaped recessed portion 12 being interposed therebetween, to each other in the axial direction.

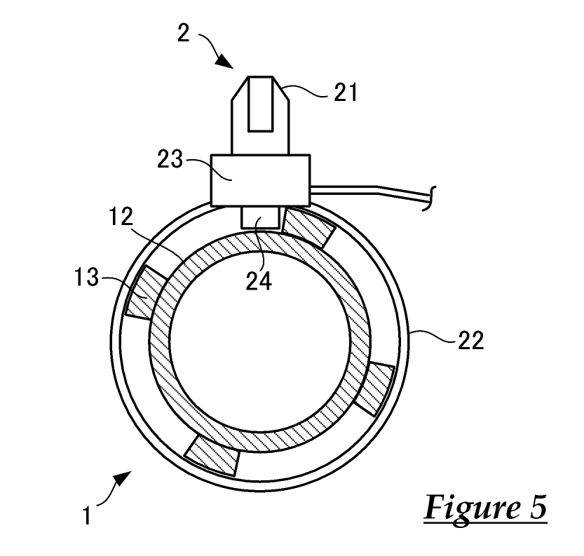

Also, the protruding portions 13 are each configured such that, when the band clip 2 is attached to the corrugated tube 1, the projecting portion 24 of the band clip 2 fitted into a ring-shaped recessed portion 12 can engage with the protruding portion 13. Thus, the protruding portions 13 are configured such that, when the band clip 2 attached to the corrugated tube 1 rotates in the circumferential direction, the projecting portion 24 engages with a protruding portion 13 as shown in FIG. 5, and the rotation of the band clip 2 is restricted.

Next, a description is given of the widths of the ring-shaped grooves 11, the projecting portion 24, and the ring-shaped recessed portions 12 in the axial direction with reference to FIG. 2A, FIG. 2B, and FIG. 4A.

In the present embodiment, as shown in FIG. 2A, FIG. 2B, and FIG. 4A, the ring-shaped grooves 11, the projecting portion 24, and the ring-shaped recessed portions 12 are formed such that the relationship W1<W2<W3 is satisfied, where W1 denotes the widths of the ring-shaped grooves 11 in the axial direction, W2 denotes the width of the projecting portion 24 of the band clip 2 in the axial direction, and W3 denotes the widths of the ring-shaped recessed portions 12 in the axial direction.

Since each element is formed such that the relationship “the widths W1 of the ring-shaped grooves 11<the width W2 of the projecting portion 24<the widths W3 of the ring-shaped recessed portions 12” is satisfied, the projecting portion 24 of the band clip 2 can be reliably fitted into a ring-shaped recessed portion 12 when the band clip 2 is attached to the corrugated tube 1. Also, when attaching the band clip 2 to the corrugated tube 1, it is possible to prevent the projecting portion 24 of the band clip 2 from being mistakenly fitted into a ring-shaped groove 11.

As described above, the structure for attaching a band clip to a corrugated tube according to the present embodiment is configured such that the projecting portion 24 of the band clip 2 is fitted into a ring-shaped recessed portion 12 of the corrugated tube 1 when the band clip 2 is attached to the corrugated tube 1. Also, the projecting portion 24 of the band clip 2 is configured such that, in the state of being fitted into a ring-shaped recessed portion 12, the projecting portion 24 can be restricted from moving in the circumferential direction due to the plurality of protruding portions 13 (four protruding portions 13 in the present embodiment) provided for the ring-shaped recessed portion 12 of the corrugated tube 1. Therefore, it is possible to reliably prevent the band clip 2 attached to the corrugated tube 1 from rotating.

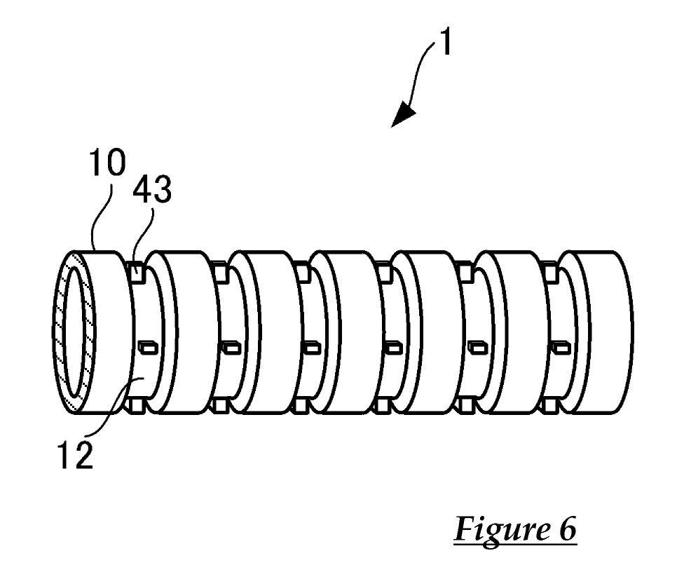

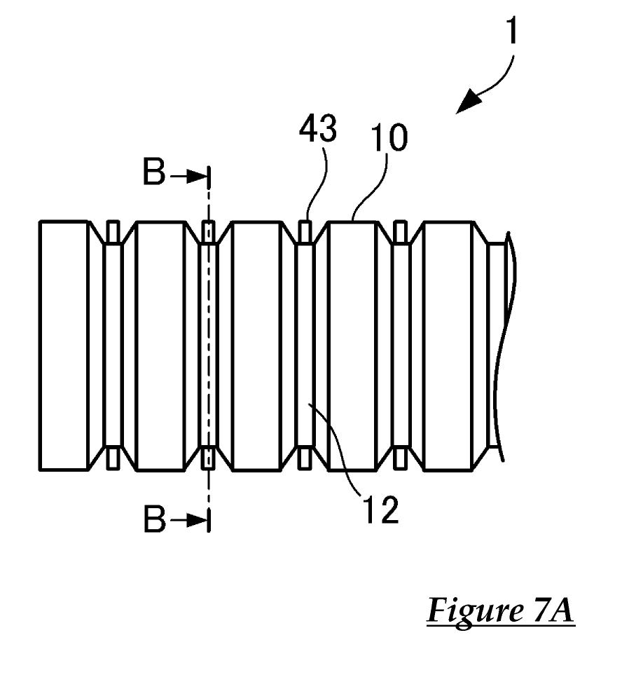

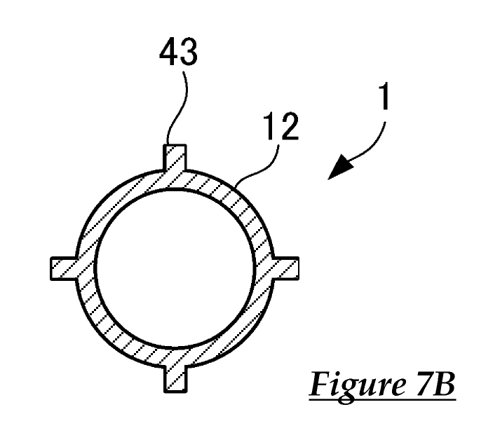

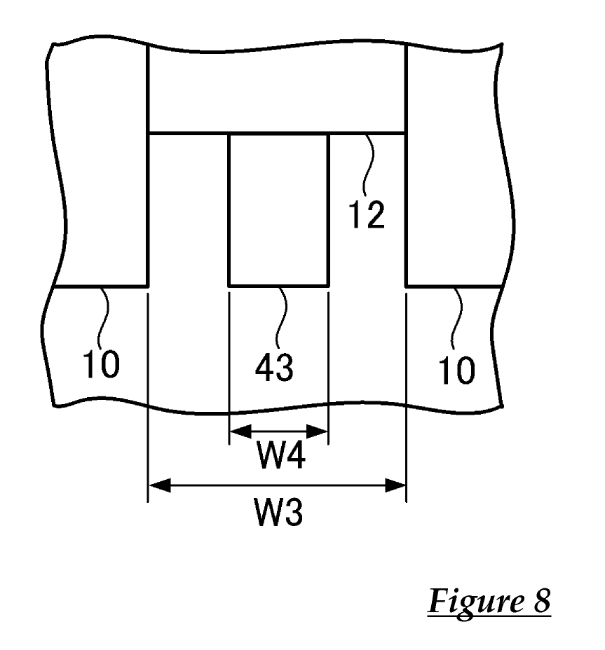

Although the protruding portions 13 of the corrugated tube 1 in the present embodiment each have a rib shape for coupling a pair of ring-shaped ribs 10 to each other in the axial direction, the present invention is not limited to this. For example, as shown in FIG. 6, FIG. 7A, FIG. 7B, and FIG. 8, protruding portions 43 that each have a projecting shape and that are each provided to be separated from the adjacent ring-shaped ribs 10 may be adopted.

Specifically, as shown in FIG. 8, the widths W4, in the axial direction, of the protruding portions 43 according to this modification are set to be smaller than the widths W3 of the ring-shaped recessed portions 12 in the axial direction. Therefore, it is possible to achieve a configuration in which any protruding portion 43 of the corrugated tube 1 does not come into contact with the pair of ring-shaped ribs 10 that the protruding portion 43 is adjacent to. Consequently, a gap is formed between each protruding portion 43 and the pair of ring-shaped ribs 10 that the protruding portion 43 is adjacent to, and the corrugated tube 1 is allowed to bend due to the presence of the gap. For this reason, it is possible to ensure preferable bendability of the corrugated tube 1.

Therefore, with the present modification, it is possible to omit the ring-shaped grooves 11 of the corrugated tube 1, to form a bellows structure with the ring-shaped recessed portions 12 and the ring-shaped ribs 10, and to provide every ring-shaped recessed portion 12 with protruding portions 43. Consequently, it is possible to ensure preferable bendability of the corrugated tube 1, and increase the number of positions along the axial direction to which the band clip 2 can be attached.

Also, as shown in FIG. 7A and FIG. 7B, as with the present embodiment, four protruding portions 43 are provided for each ring-shaped recessed portion 12, and these four protruding portions 43 are displaced from one another by 90° in the circumferential direction. In the present modification, it is possible to ensure preferable bendability of the corrugated tube 1 as described above, and it is therefore possible to increase the number of protruding portions 43 to be greater than the number of those in the present embodiment. If this is the case, the range of rotation of the band clip 2 can be further limited.

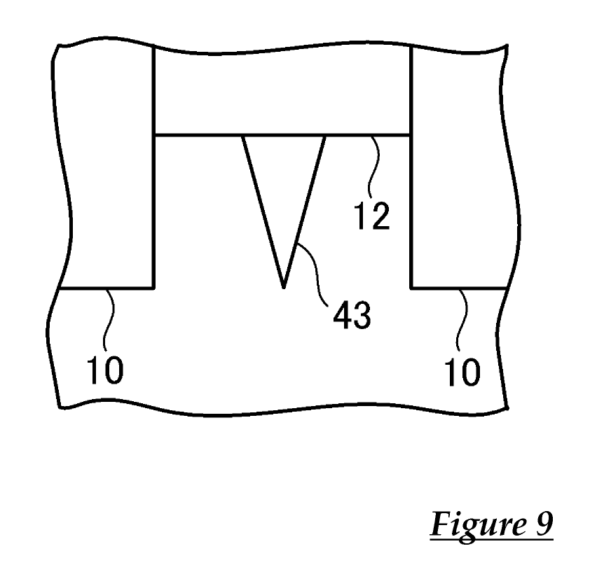

Although the protruding portions 43 in the present modification each have a cubic shape, any shape may be adopted as long as the projecting portions 24 of the band clip 2 can be engaged with the protruding portions 43. For example, as shown in FIG. 9, the protruding portions 43 in the present modification may each have a triangular shape when seen in the circumferential direction, and various shapes such as a columnar shape and a warhead shape may be adopted.

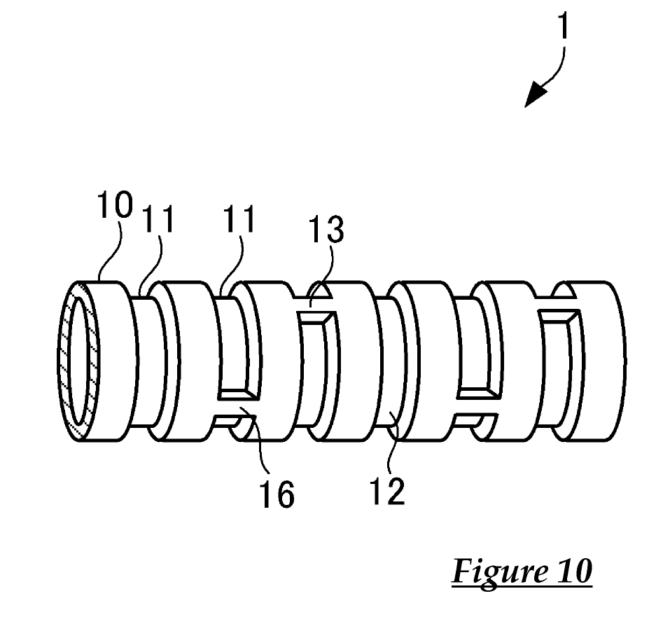

Also, in the present embodiment, although a description has been given of an example in which four protruding portions 13 are provided for each ring-shaped recessed portion 12, two protruding portions 13 may be provided for each ring-shaped recessed portion 12 as shown in FIG. 10. If this is the case, the protruding portions 13 are displaced from each other by 180° in the circumferential direction.

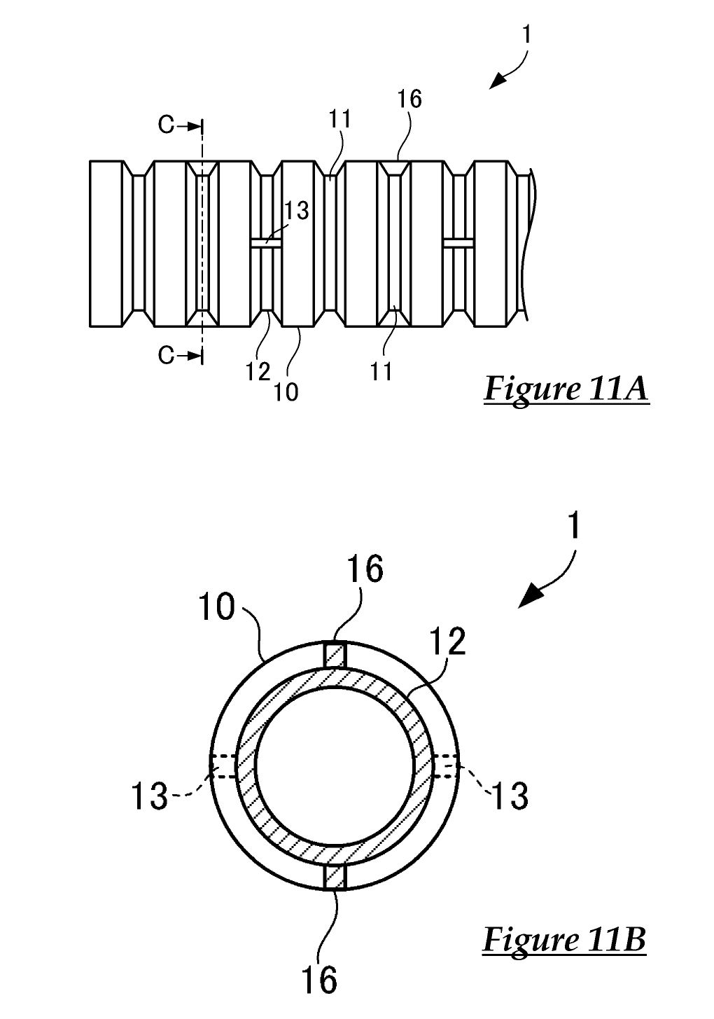

However, if the number of protruding portions 13 is two, the corrugated tube 1 is likely to bend only in the upward or downward direction in FIG. 11A at the ring-shaped recessed portions 12, the bendability of the corrugated tube 1 becomes imbalanced.

For this reason, in the example shown in FIG. 10, one of a pair of ring-shaped grooves 11 that are adjacent to a ring-shaped recessed portion 12 is additionally provided with a rib 16 that couples, in the axial direction, a pair of ring-shaped ribs 10 that are adjacent to each other with the ring-shaped groove 11 being interposed therebetween. As shown in FIG. 11B, two ribs 16 are arranged such that their phases are shifted from the phases of the two protruding portions 13 by 90° in the circumferential direction.

Consequently, it is possible to achieve balanced bendability of the corrugated tube 1, with which the corrugated tube 1 is free from the problem of being likely to bend only in one direction, and it is possible to ensure preferable bendability.

In the embodiment and the modification above, a description has been given of configurations in which the band clip 2 is provided with a single projecting portion 24. However, the present invention is not limited to this. For example, two projecting portions 24 may be provided at predetermined intervals along the direction that is orthogonal to the axial direction. If this is the case, a configuration may be adopted in which the two projecting portions 24 sandwich a protruding portion 13, and the band clip 2 can be further prevented from rotating.

In the embodiment and the modification above, a description has been given of examples in which the projecting portion 24 is provided on the clip locking portion 23. However, the present invention is not limited to this, and the projecting portion 24 may be provided on the belt portion 22.

As described above, the structure for attaching a band clip to a corrugated tube according to one aspect of the present invention has the advantageous effect that the band clip attached to the corrugated tube can be reliably prevented from rotating, and is applicable to various kinds of structures for attaching a band clip to a corrugated tube.

### REFERENCE SIGNS LIST

1 Corrugated tube

2 Band clip

4 Attachment target object

10 Ring-shaped rib

11 Ring-shaped groove

12 Ring-shaped recessed portion

13 Protruding portion

16 Rib

21 Clip portion

22 Belt portion

23 Clip locking portion

23a Belt insertion hole

24 Projecting portion

43 Protruding portion

W1 Width

W2 Width

W3 Width

### CITATION LIST

### Patent Documents

Patent Document 1: JP2013-46505A

1. A structure for attaching a band clip to a corrugated tube, comprising:
a corrugated tube that has a plurality of ring-shaped ribs and a plurality of ring-shaped grooves, and that is for enclosing a wire harness; and
a band clip for fixing the corrugated tube to an attachment target object, wherein
the band clip has a projecting portion that projects toward an outer circumferential surface of the corrugated tube when the band clip is attached to the corrugated tube,
the corrugated tube has: a groove-shaped ring-shaped recessed portion that is provided in parallel with the ring-shaped grooves and into which the projecting portion is fittable; and a plurality of protruding portions that are provided at predetermined intervals in a circumferential direction of the ring-shaped recessed portion, and that are engageable with the projecting portion, and
when the band clip is rotated in the circumferential direction relative to the corrugated tube, rotation of the projecting portion is restricted within any of the predetermined intervals, so that a range of rotation of the band clip is limited.

2. The structure for attaching a band clip to a corrugated tube according to claim 1, wherein
the ring-shaped grooves, the projecting portion, and the ring-shaped recessed portion are formed such that a relationship W1<W2<W3 is satisfied, where W1 denotes widths of the ring-shaped grooves in an axial direction that is orthogonal to the circumferential direction, W2 denotes a width of the projecting portion in the axial direction, and W3 denotes a width of the ring-shaped recessed portion in the axial direction.

3. The structure for attaching a band clip to a corrugated tube according to claim 1, wherein:
widths of the protruding portions in an axial direction that is orthogonal to the circumferential direction are set to be smaller than a width of the ring-shaped recessed portion in the axial direction.

4. The structure for attaching a band clip to a corrugated tube according to claim 2, wherein:
widths of the protruding portions in the axial direction are set to be smaller than widths of the ring-shaped grooves in the axial direction.
